(19) United States
(12) Patent Application Publication
(10) Pub. No.: US 2020/0130277 A1
(43) Pub. Date: Apr. 30, 2020

(54) HANDHELD 3D BIOPRINTER

(71) Applicant: SMR Patents S.à.r.l., Luxembourg (LU)

(72) Inventors: Dylan THORPE, Glandore (AU); Simon BELCHER, South Plympton (AU); James NICHOLSON, Belair (AU)

(21) Appl. No.: 16/494,377

(22) PCT Filed: Nov. 15, 2017
(86) PCT No.: PCT/EP2017/079283

§ 371 Date: Sep. 16, 2019

(30) Foreign Application Priority Data
Mar. 15, 2017 (AU) 2017900906

(51) Int. Cl. B29C 64/336; B29C 64/393; B33Y 50/02; B33Y 30/00; B29C 64/106; B29C 64/209; B29C 64/255; B33Y 40/00; B29C 64/264

(52) U.S. Cl. CPC B29C 64/336; B29C 64/393; B33Y 50/02; B33Y 30/00; B29L 2031/7532; B29C 64/209; B29C 64/255; B33Y 40/00; B29C 64/264; B29C 64/106

(57) ABSTRACT

A handheld 3D printing apparatus for printing biocompatible materials including stem cells for performing in-situ surgical repairs and comprises one UV curable reagent container and one cell supporting reagent container which are co-axially extruded from a tip and cured to perform in-situ repairs. The extruded material comprises a core material protected by a shell material. The reagents are driven from the containers using an electronic drive train at a constant rate.

### CROSS-REFERENCE TO RELATED APPLICATION

This application is a National Stage Entry of International Patent Application No. PCT/EP2017/079283, filed Nov. 15, 2017, which claims priority from Australian provisional patent application 2017900906, filed Mar. 15, 2017, each of which is hereby incorporate by reference in its entirety for all purposes.

### TECHNICAL FIELD

The present disclosure relates to additive manufacturing of biocompatible materials. In a particular form the present disclosure relates to a handheld 3 dimensional (3D) printing of biocompatible materials for surgical biofabrication.

### BACKGROUND

Laboratory studies and prototypes have established the technical feasibility of a handheld 3D printer for surgical biofabrication. In one recent (although not necessarily well known) prototype system UV curable inks containing stem cells and biomaterials are in-situ printed and UV cured to allow a surgeon to biofabricate a tissue structure, for example to directly repair damaged cartilage. In this prototype system two reagent containers separately store the stem cells and biomaterial as hydrogels and a mechanical extrusion system is used to extrude the reagents through 3D printed titanium extruder nozzle, and a UV light source is used to cross-link the hydrogels immediately after extrusion to form a stable structure that encapsulates and supports the stem cells. A foot pedal is used to control reagent extrusion and the rate of extrusion is controlled using an electronic control interface. Each extruder has a circular cross section and is deposited co-axially with a core material containing the stem cells and a shell material which encapsulates and supports the core material

However, while technical feasibility has been established with the above discussed prototype, this prototype has a number of disadvantages, particular to enable cost effective production and reliable use. For example, the prototype device suffers from reliability and consistency issues. The viscosity and thus flow rate of the reagents are sensitive to temperature and the material properties are sensitive to the mixing ratio. This then requires tight control of the extrusion rates. Additionally, the prototype device has limited freedom of movement as it is connected by cables to a foot pedal and an electronic control interface. Further, the nozzle is a 3D printed titanium nozzle which is expensive and unsuitable for volume manufacturing.

There is thus a need to provide an improved handheld 3D printing device, or at least an alternative to existing handheld 3D printing device.

### SUMMARY

According to a first aspect, there is provided a handheld 3D printing apparatus for extruding multiple reagent compositions, the apparatus including:

a housing having: a first reagent container support arrangement which in use receives and supports a first reagent container containing a stem cell supporting reagent; a second reagent container support arrangement which in use receives and supports a second reagent container containing a light curable reagent; a power supply; an electric drive train arrangement configured to drive a first reagent piston into a distal end of the first reagent container, and to drive a second reagent piston into a distal end of the second reagent container; an electronic control circuit to control the electric drive train to control extrusion of the reagents from the first and second reagent containers; a nozzle connected at a distal end to the housing and including a co-extrusion tip including at least one aperture, and a first conduit for receiving the first reagent driven out of a proximal end of the first reagent container and directing the first reagent out of the at least one aperture in the tip, and a second conduit for receiving the second reagent driven out of a proximal end of the second reagent container and directing the second reagent out of the at least one aperture in the tip.

The extruded material can be cured using an external light source. In another example, the handheld 3D printing apparatus may further include a light source mounted on or in the nozzle and controlled by the electronic control circuit for curing the reagents either just prior or after extrusion from the tip. These and other features will now be described.

In a further aspect, there is provided the use of the handheld 3D printing apparatus for extruding radiation curable reagent compositions. The radiation curable reagent composition may additionally be cured by using the handheld 3D printing apparatus.

### BRIEF DESCRIPTION OF DRAWINGS

Embodiments of the present disclosure will be discussed with reference to the accompanying drawings wherein:

FIG. 1A is an isometric view of a handheld 3D printing apparatus according to an embodiment;

FIG. 1B is an exploded isometric view of the handheld 3D printing apparatus of FIG. 1A;

FIG. 1C is an exploded top view of the handheld 3D printing apparatus of FIG. 1A;

FIG. 1D is an exploded side view of the handheld 3D printing apparatus of FIG. 1A;

FIG. 1E is an exploded end view of the handheld 3D printing apparatus of FIG. 1A;

FIG. 2A is an isometric view of a nozzle of a handheld 3D printing apparatus according to an embodiment;

FIG. 2B is an top view of the handheld 3D printing apparatus of FIG. 2A;

FIG. 2C is side view of the handheld 3D printing apparatus of FIG. 2A;

FIG. 2D is an end view of the handheld 3D printing apparatus of FIG. 2A;

FIG. 2E is a sectional view through section AA of FIG. 2C prior to insertion of the core tube;

FIG. 2F is a sectional detail view through feature F of FIG. 2E;

FIG. 2G is a another sectional view through section AA of FIG. 2C in final form after sealing and insertion of the core tube;

FIG. 2H is a sectional detail view through feature H of FIG. 2G;

FIG. 3A is an isometric view of a handgrip portion of a handheld 3D printing apparatus according to an embodiment;

FIG. 3B is an isometric view of a first reagent container according to an embodiment;

FIG. 3C is an isometric view of a second reagent container according to an embodiment;

FIG. 4A is an isometric view of an upper section of a rear housing of a handheld 3D printing apparatus according to an embodiment;

FIG. 4B is an isometric view of a lower section of a rear housing of a handheld 3D printing apparatus according to an embodiment;

FIG. 5A is an isometric view of a drive train arrangement according to an embodiment;

FIG. 5B is an exploded isometric view of the drive train arrangement of FIG. 5A;

FIG. 5C is an isometric view of a jack screw in the drive train arrangement of FIG. 5A;

FIG. 5D is an isometric view of a jack spur gear in the drive train arrangement of FIG. 5A;

FIG. 5E is an isometric view of a stepper motor in the drive train arrangement of FIG. 5A;

FIG. 5F is an isometric view of a drive cap in the drive train arrangement of FIG. 5A;

FIG. 5G is an isometric view of a drive cradle in the drive train arrangement of FIG. 5A;

FIG. 5H is an top view of the drive cradle in the drive train arrangement of FIG. 5A;

FIG. 5I is an end view of the drive cradle in the drive train arrangement of FIG. 5A;

FIG. 6A is an isometric view of a nozzle of a handheld 3D printing apparatus according to another embodiment;

FIG. 6B is an isometric view of a nozzle of a handheld 3D printing apparatus according to another embodiment;

FIG. 6C is an end view of the nozzle of FIG. 6B;

FIG. 6D is a sectional view through section DD of FIG. 6C;

FIG. 6E is an isometric view of a nozzle of a handheld 3D printing apparatus according to another embodiment;

FIG. 6F is an end view of the nozzle of FIG. 6B;

FIG. 6G is a sectional view through section GG of FIG. 6F;

FIG. 7A is an isometric view of a two part extruder tip according to an embodiment;

FIG. 7B is an exploded view of the two part extruder tip of FIG. 7A;

FIG. 7C is an isometric view of the tip cap of the two part extruder tip of FIG. 7A;

FIG. 7D is a side view of the two part extruder tip of FIG. 7A;

FIG. 7E is a front view of the two part extruder tip of FIG. 7A;

FIG. 7F is a sectional view along section HH of FIG. 7E;

FIG. 8 is an exploded view of a side loading embodiment;

FIG. 9A is an isometric view of a back loading embodiment;

FIG. 9B is another isometric view of the back loading embodiment of FIG. 9A;

FIG. 10 is an isometric view of an embodiment with a pistol grip;

FIG. 11A shows a section of knee cartilage with a damaged section according to an embodiment;

FIG. 11B shows the knee cartilage with the damaged section excised;

FIG. 11C shows an embodiment of the biopen printing a biomaterial into the excised section to repair the knee cartilage.

FIG. 12A shows a first isometric view of an embodiment with a rear hinge;

FIG. 12B shows a second isometric view the embodiment shown in FIG. 12A

FIG. 12C is an exploded view of the embodiment shown in FIG. 12A;

FIG. 12D is a top view of the embodiment shown in FIG. 12A with the upper housing removed;

FIG. 12E is a side view of the embodiment shown in FIG. 12A;

FIG. 12F is a bottom view of the embodiment shown in FIG. 12A;

FIG. 12G is a front view of the embodiment shown in FIG. 12A;

FIG. 12H is a sectional view through section SS of FIG. 12D;

FIG. 12I is a side view of the embodiment shown in FIG. 12A with the top cover open;

FIG. 12J is a bottom view of the embodiment shown in FIG. 12A with the lower housing removed;

FIG. 12K is a sectional view through section YY of FIG. 12D;

FIG. 12L is a sectional view through section ZZ of FIG. 12D;

FIG. 12M is a schematic view of the user interface of the embodiment shown in FIG. 12A

FIG. 13A is a side view of the nozzle assembly in the embodiment shown in FIG. 12A;

FIG. 13B is another side view of the nozzle assembly in the embodiment shown in FIG. 12A;

FIG. 13C is an end view of the nozzle assembly in the embodiment shown in FIG. 12A;

FIG. 13D is an isometric view of the nozzle assembly in the embodiment shown in FIG. 12A;

FIG. 13E is a top view of the nozzle assembly in the embodiment shown in FIG. 12A, and FIG. 13F is an section view of the nozzle assembly through section AA of FIG. 13E;

FIG. 14A is a first isometric view of triple barrel concentric syringe assembly according to an embodiment;

FIG. 14B is a second isometric view of the triple barrel concentric syringe assembly of FIG. 14A;

FIG. 14C is an exploded view of the triple barrel concentric syringe assembly of FIG. 14A;

FIG. 14D is a top view of the triple barrel syringe concentric assembly of FIG. 14A;

FIG. 14E is a section view through section AA of FIG. 14D;

FIG. 14F is a side view of the triple barrel syringe concentric assembly of FIG. 14A;

FIG. 14G is a section view through section BB of FIG. 14G;

FIG. 14H is a front view of the triple barrel syringe assembly of FIG. 14A;

FIG. 14I is a rear view of the triple barrel syringe assembly of FIG. 14A;

FIG. 14J is a close up of the nozzle assembly of FIG. 14E; and

FIG. 14K is a close up of the nozzle assembly of FIG. 14G.

In the following description, like reference characters designate like or corresponding parts throughout the figures.

### DETAILED DESCRIPTION

According to a general embodiment of the present invention, the handheld 3D printing apparatus has a nozzle connected at a distal end to the housing and comprising a co-extrusion tip comprising at least one aperture, and a first conduit for receiving the first reagent driven out of a proximal end of the first reagent container and directing the first reagent out of the at least one aperture in the tip, and a second conduit for receiving the second reagent driven out of a proximal end of the second reagent container and directing the second reagent out of the at least one aperture in the tip. This means, that the two reagents are contacted, for example mixed, prior to being extruded from the nozzle tip.

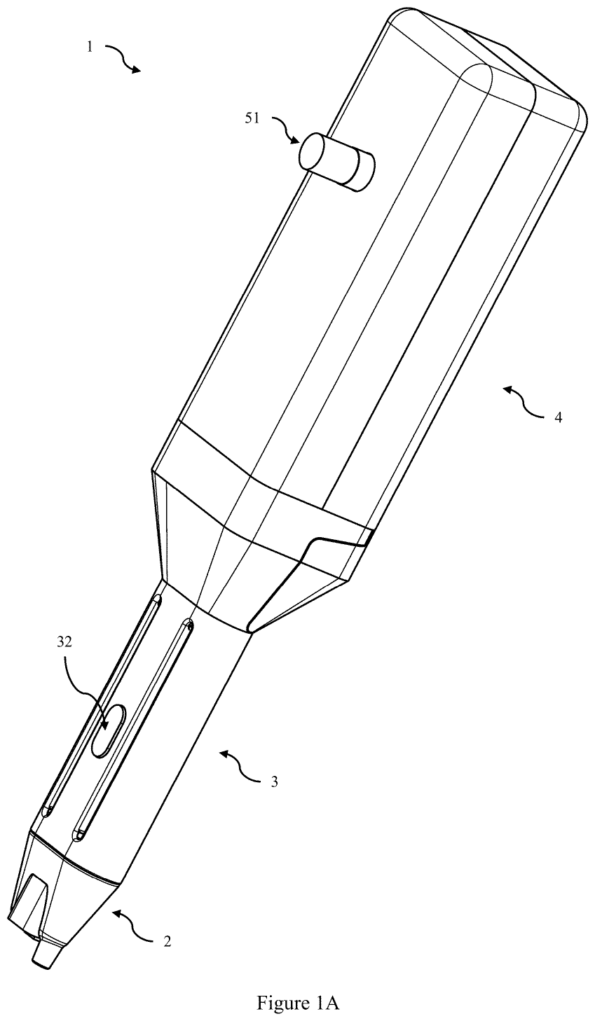

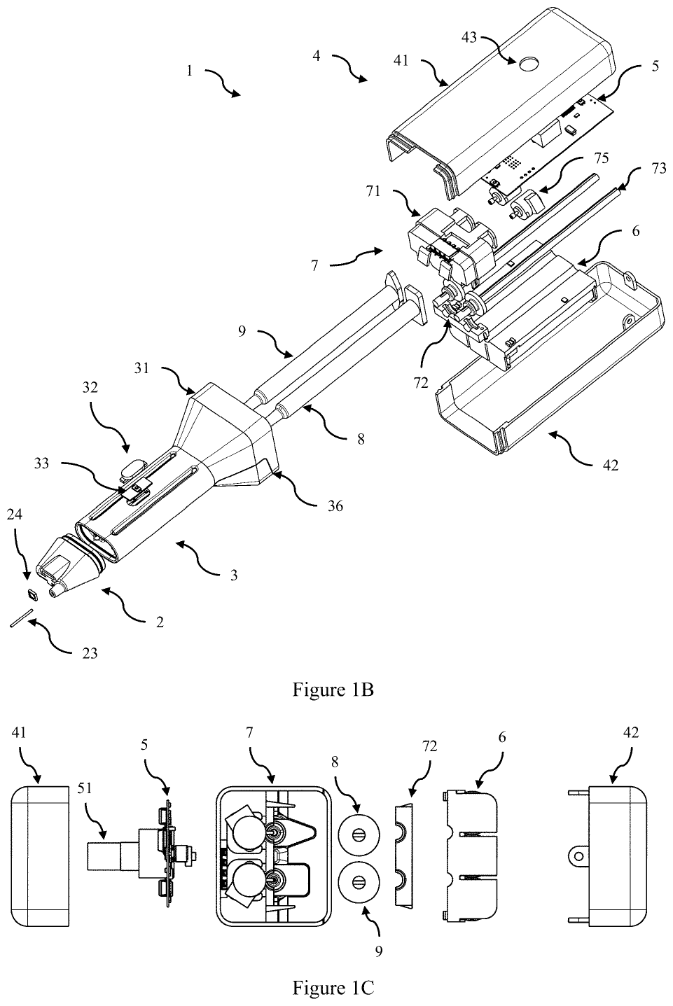

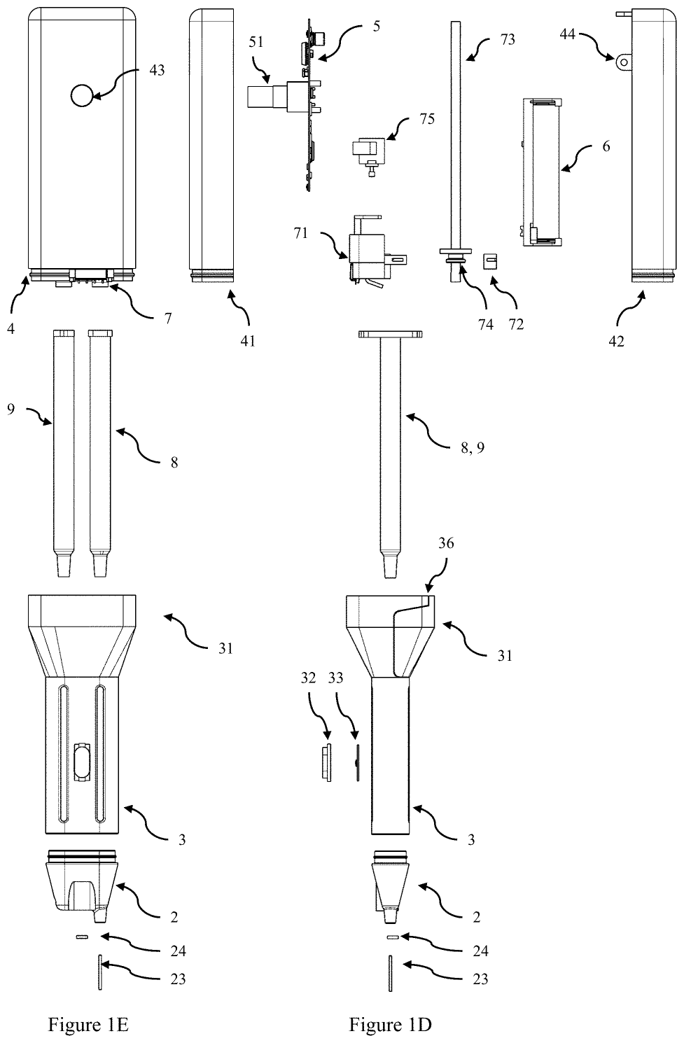

In one embodiment, the handheld 3D printing apparatus has a nozzle comprising a core aperture and an annular aperture in a coaxial arrangement, and a first conduit for receiving the first reagent driven out of a proximal end of the first reagent container and directing the first reagent out of the core aperture in the tip, and a second conduit for receiving the second reagent driven out of a proximal end of the second reagent container (9) and directing the second reagent out of the annular aperture in the tip. Referring to FIG. 1A, there is shown an embodiment of a handheld 3D printing apparatus for extruding and curing radiation curable reagent compositions which will be referred to as a biopen. The handheld 3D printing apparatus 1 or biopen comprises a nozzle 2 and a housing. The nozzle defines the proximal end and the housing defines the distal end. In the embodiment shown in FIG. 1A, the housing is formed from a handgrip 3 and a rear housing 4. A start/stop (i.e. on/off) button 32 is provided on the handgrip and in this embodiment the user interface 51 comprises a speed control knob. However in some embodiments the speed could be fixed in which case the speed control knob is omitted.

FIG. 1B is an exploded isometric view of the handheld 3D printing apparatus of FIG. 1A, and FIGS. 1C, 1D and 1E are exploded top, side and end views. As will be explained in more detail below, the handheld 3D printing apparatus or biopen comprises a first reagent container support arrangement 35 (cf. FIG. 3A) which in use receives and supports a first reagent container 8 containing a first stem cell supporting reagent. The handheld 3D printing apparatus or biopen also comprises a second reagent container support arrangement 35 (cf. FIG. 3A). which in use receives and supports a second reagent container 9 containing a light curable reagent. In this embodiment these are located in the handgrip. In this embodiment the apparatus is approximately 175 mm in length and the rear housing is approximately square with 30 mm sides, and weight is less than 100 grams allowing it to be easily held and operated in a single hand. Other sizes and weights of the apparatus are encompassed by the present invention. In one embodiment the apparatus is specifically designed for a right hander, whereas in another embodiment the apparatus is specifically designed for a left hander. Alternatively the apparatus can be designed as ambidextrous.

The rear housing 4 comes in a an upper section 41 and a lower section 42 and houses a power supply 6, such as alkaline, lithium ion or other batteries (e.g. 3 AAA alkaline batteries or any other number of batteries), an electric drive train arrangement 7 which is configured to drive a first reagent piston 84 into a distal end 81 of the first reagent container 8, and to drive a second reagent piston 94 into a distal end 91 of the second reagent container 9. An electronic control circuit 5 is used to control the electric drive train 7 to control extrusion of the reagents from the first and second reagent containers 8 and 9.

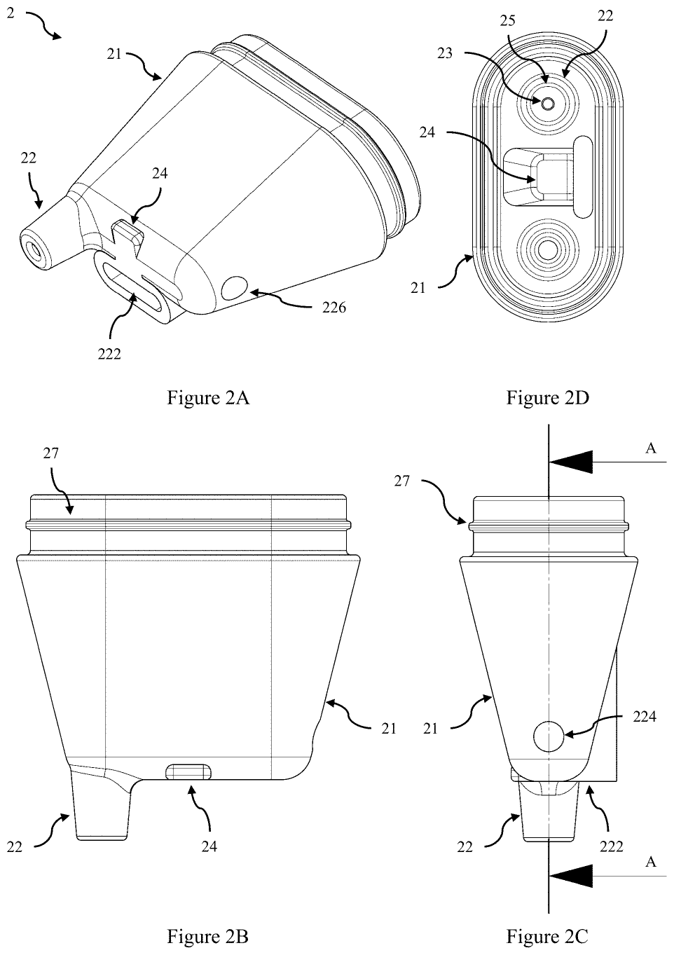

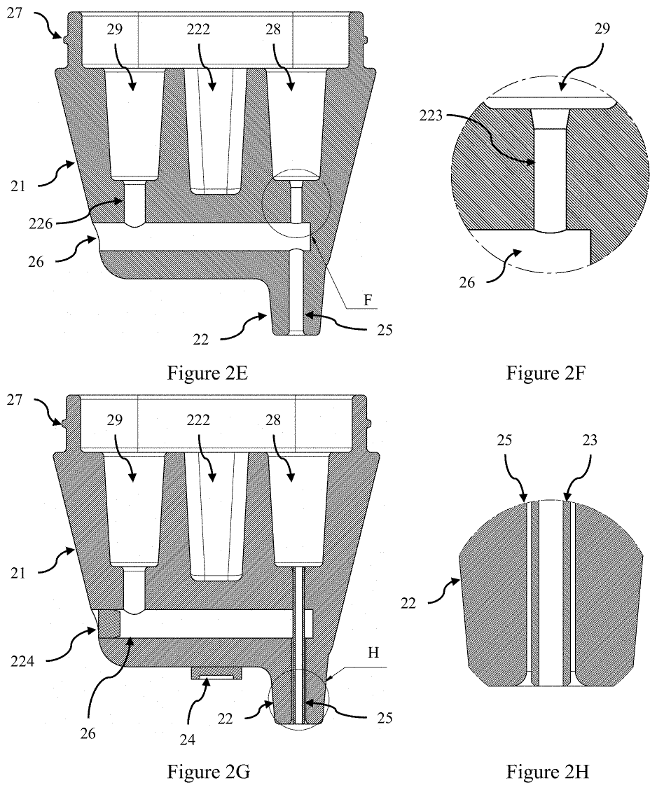

An embodiment of the nozzle 2 is shown in FIGS. 2A to 2H. FIGS. 2A, 2B, 2C and 2D are isometric top, side and end views respectively. The nozzle 2 comprises a manifold housing 21 with the distal end comprising a retention rib to allow connection of the nozzle to the distal end to the housing/hand grip 3. At the proximal end the nozzle comprises a co-extrusion tip 22 with a core aperture 23 and an annular aperture 25 in a coaxial arrangement. In this embodiment, a light source 24 is mounted on or in the nozzle and controlled by the electronic control circuit 5 for curing the reagents either just prior or after extrusion from the tip 22. In the embodiment shown in FIGS. 2A to 2D and 2G the light source 24 is a UV LED mounted on the proximal end of the nozzle to irradiate the reagents after they are extruded from the tip. In one embodiment the light source further comprises a lens and focuses the light in a zone at the end of the tip, for example 1-3 mm from the tip, 1-5 mm, 1-10 mm or the like. Other light sources suitable for curing the reagents may be possible. A conduit 222 is provided for the LED cable. In this embodiment the LED 24 is located on the lower side of the nozzle (i.e. opposite side to on/off button 33) and the conduit 222 is provided on the upper side. This ensures that UV light is directed downward and that the conduit 222 and nozzle 2 partially shields or blocks emission back towards the user. In other embodiments, further guards may be used to minimise or control the direction of emission to reduce unwanted exposure to the patient or operator. The UV light source may generate radiation in the wavelength from 100-420 nm, such as 200-420 nm or 300-420 nm. In one embodiment the wavelength is 350-420 nm. The light source could be a UV LED or UV laser diode, along with focusing optics (lenses, etc) and guards or shields to block and control the emission direction. In other embodiments the device could be used with different materials with different curing wavelengths (not necessarily UV wavelengths), in which case the light source would be selected to match the curing wavelength. In other embodiments the light source could be omitted from the apparatus, and extruded material can be cured using a separate remote or external light source and external light guides. Such external light source may be selected from the group of light sources mentioned above.

The nozzle 2 comprises a manifold housing 21 which comprises a first conduit that receives the first reagent driven out of the proximal end of the first reagent container 8 and directs the first reagent out of the core aperture 23 in the tip 22. A second conduit 26 receives the second reagent driven out of a proximal end of the second reagent container 9 and directs the second reagent out of the annular aperture 25 in the tip 22. The reagents are thus extruded as a coaxial bead of material with the first reagent forming the core material and the second reagent forming a shell material which surrounds, protects and supports the core material. The first or core reagent material may comprise stem cells and support media in a hydrogel or paste. The second or shell reagent material will typically have a different composition in line with providing a protecting and structural support role for the core material, and may or may-not comprise stem cells. The second reagent material may be provided as a hydrogel or paste. The hydrogels may be comprised of a hyaluronic acid, methacrylic anhydride, agarose, methylcellulose, gelatine or the like.

The nozzle in this embodiment is suitable for manufacture using plastic injection moulding and the internal structure of an embodiment of the nozzle is shown in more detail in FIGS. 2E to 2H. FIG. 2E is a sectional view through section AA of FIG. 2C of the nozzle after moulding and prior to insertion of the a core tube 23 and manifold plug 224, and FIG. 2G is another sectional view through section AA of FIG. 2C in the final form after insertion of the core tube and manifold plug. The configuration of the coaxial tip 22 is further illustrated in FIG. 2F which is a sectional view through feature F of FIG. 2E and FIG. 2H which is a sectional view through feature H of FIG. 2G.

As shown in the embodiment of FIG. 2E, the manifold housing 21 comprises a first cavity 28 for receiving the proximal end 83 of the first or core reagent container 8, and a second cavity 29 for receiving the proximal end 93 of the second or shell reagent container 9. A first conduit 223, shown in more detail in FIG. 2F extends from the first cavity 28 to the manifold 26 and a second conduit 226 extends from the second cavity 29 to the manifold 26. A first or shield tube 25 extends from the manifold 26 to the tip 22, and is a larger diameter than the first conduit 223. As can be seen in FIGS. 2E and 2G the manifold 26 is initially open to the outer wall of the manifold housing 21 (to allow moulding of the interior of the nozzle) and thus a manifold plug 224 is provided to seal the manifold 26. The co-axial co-extrusion tip 22 is formed by inserting a core tube (or hollow hypodermic needle like tube) 23 into the first or shield tube 25 and through the manifold 26 into the first cavity 28 via the first conduit 223. The first conduit 223 is dimensioned to have a diameter similar to the external diameter of the core tube 23 to ensure a snug and secure fit to prevent leakage of the first reagent into conduit 26. FIG. 2F shows the nozzle 22 after insertion of the core tube 23. In use the first or core reagent is located within and extruded from core tube 23, and the second or shell reagent flows in the annular gap between the outer surface of the core tube 23 and inner wall of the first tube 25. The first conduit 223 acts to locate and centre the core tube 23 within the first tube 25 to ensure co-axial extrusion.

In this embodiment the light source 24 is a UV LED mounted externally on the nozzle to cure the reagents after extrusion from the tip. As shown in FIGS. 2E and 2G a conduit 222 is provided for cables supplying power to the LED. In another embodiment a UV light source may be located internally within the manifold 26 in order to irradiate the second (shield) reagent whilst in manifold 26 just prior to extrusion from the tip. In this embodiment the manifold plug 224 is replaced with an LED inserted through the opening the manifold plug 224 is normally located in. This approach limits or prevents radiation exposure to the user or patient as UV light/radiation is confined to be substantially internal to the nozzle 2 with only minimal light leakage out of the tip 22.

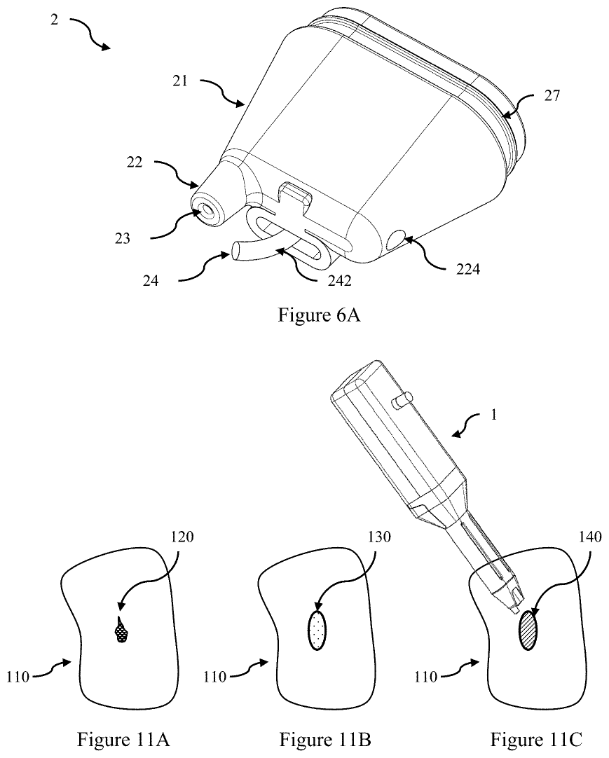

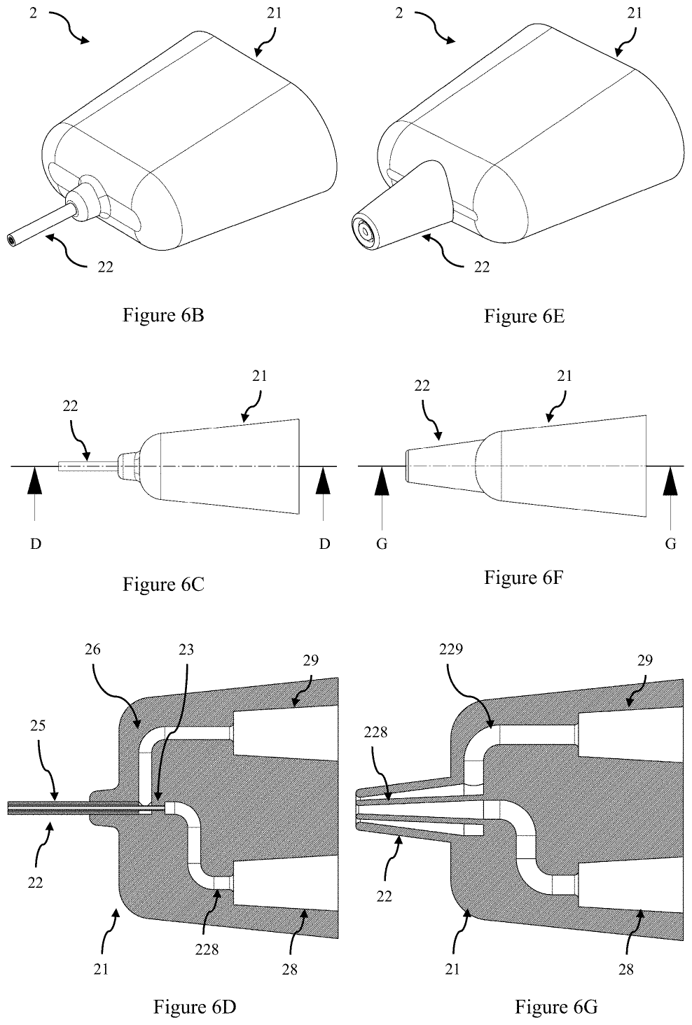

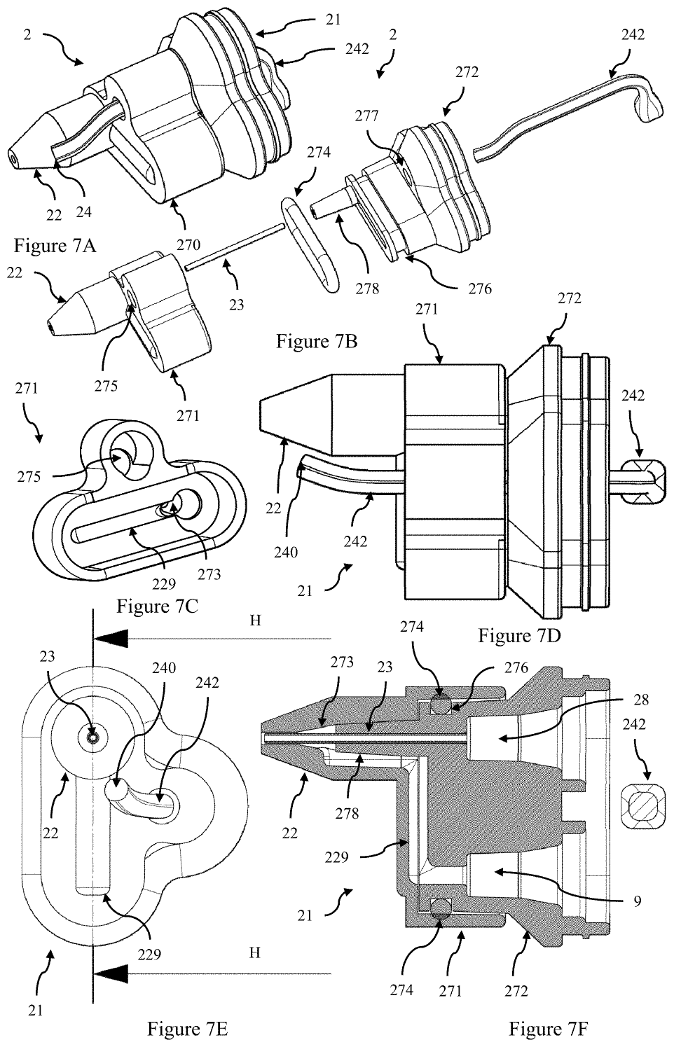

Further embodiments of the nozzle 2 are illustrated in FIGS. 6A to 6G, and 7A to 7F. FIG. 6A is an isometric view of a nozzle of a handheld 3D printing apparatus according to another embodiment. In this embodiment a light pipe 225 extends from an internal light source (e.g. UV LED) located within the nozzle 2. This allows the light to be directed onto the reagents as they are extruded from the tip 22. FIGS. 6B to 6D show an isometric, end view and sectional view (through section DD of FIG. 6C) of another embodiment of a nozzle 2 with the extrusion tip formed from two coaxial hypodermic needle like tubes. In this embodiment the nozzle housing 21 is formed without the co-extrusion tip 22 using plastic injection moulding. The co-extrusion tip 22 is formed by first inserting the shell tube 25 into a tubular aperture formed in the proximal end of the nozzle until it reaches the manifold 26, and then inserting the core tube 23 inside the shell tube 25 until it engaged with the first conduit 228. Alternatively the order of insertion could be reversed, or the core tube 23 could be first inserted inside the shell tube 25, and the co-axial tubes inserted into the proximal end of the nozzle housing 21.

FIGS. 6E to 6G show an isometric, end view and sectional view (through section GG of FIG. 6F) of another embodiment of a nozzle 2 with a directly formed coaxial co-extrusion tip 22. That is unlike the previous embodiments there is no requirement to insert a core tube 23 into a formed shell tube 25 to form the tip 22. In this embodiment the first conduit 228 leads directly to the tip 22—that is the proximal end of the first conduit 228 forms the core tube 23. Similarly the second conduit 229 leads directly to the tip 22 and is formed such that it co-axially surround the core tube 23 (228). This co-extrusion tip is more challenging to make using injection moulding but could alternatively be 3D printed.

FIGS. 7A to 7F illustrate an embodiment of a two part extruder tip. FIG. 7A is an isometric view, FIG. 7B is an exploded view, FIG. 7C is an isometric view of the tip cap 271, FIG. 7D is a side view, FIG. 7E is a front view and FIG. 7F is a sectional view of section HH of FIG. 7E. In this embodiment the two part extruder tip comprises a tip cap 271 and a tip rear 272 which can be clipped together. The tip rear 272 comprises a seal recess 276 which received a seal 274. A light pipe 225 from the circuit board 5 passes through a rear aperture 277 in the tip rear, and forward aperture 275 in the tip cap 271, so that the tip of the light pipe 242 can be directed onto extruded material from the tip 22. Internally a hypodermic tube 23 is inserted into hypodermic support structure 278 extending forward of the tip rear 272 and into chamber 28. The tip cap 271 comprises a channel 229 for receiving shell reagent from cavity 29 and the channel leads to a forward cavity 273 which also receiving the hypodermic support structure 278 and hypodermic tube. Clearance is provided around the hypodermic tube 23 to allow the shell reagent to flow out of the tip with stem cell reagent.

The handgrip portion 3 is shown in greater detail in FIG. 3A, and FIGS. 3B and 3C are isometric views of the first and second reagent containers 8 and 9. The handgrip portion 3 comprises a housing 31 with a hinged portion 36 to allow the housing to be opened up (shotgun like) to receive and load the first and second reagent containers 8 and 9. Alternatively the hinged portion may be omitted and this section left open. The reagent containers 8 and 9 are each formed as a cylindrical tube 82, 92 with a tapered proximal end 83, 93 and a flange 81, 91 at the distal end. Reagent pistons 84 and 94 are located at the distal end to enable reagent to be pushed out of the proximal end of the reagent containers. The first flange 81 has a first profile shape, in this embodiment a rectangular shape, and the second flange 91 may have a second profile shape different to the first profile shape, in this embodiment a diamond like profile shape. The handgrip comprises a reagent container support arrangement (or interface) 35 with a first cut-out portion matching the first profile shape 81 of the first reagent container and a second cut-out portion matching the second profile shape 91 of the second reagent container. This creates an error proof interface to ensure correct loading of the first and second reagent containers into the handgrip (and into the nozzle 2) to ensure the first reagent feeds the core tube 23 and the second reagent 9 feeds the shield tube 25. In other embodiments, a colour matching scheme could be used, such as a red syringe in a red hole or flange, and a green syringe in a green hole or flange. In one embodiment the reagent containers are modified syringe bodies such as Luer slip syringes. Reagent container volumes would typically be in the range of 0.5 cc-5 cc.

The main elongated body of the handgrip 3 further comprises a first viewing aperture 38 for viewing the first reagent in the first reagent container, and a second viewing aperture 39 for viewing the second reagent in the second reagent container. In this way a user can observe how much reagent has been used or is remaining in each reagent container. An aperture 34 is also provide for a start/stop (or on/off) button 34 which engages with a toggle switch (or actuator) 33 fitted in or below the aperture 34 and connected to the electronic control board 5 (and power supply 6).

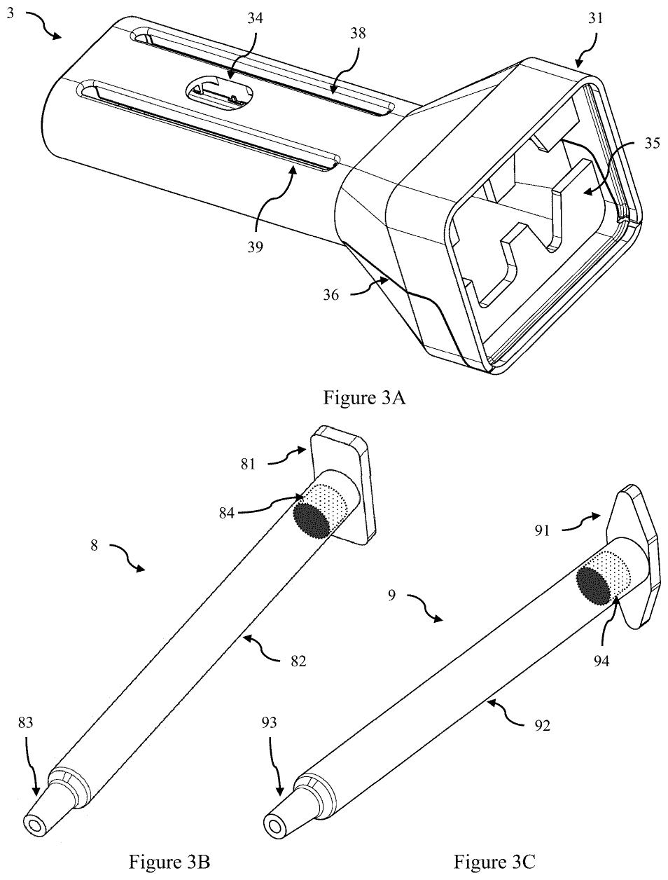

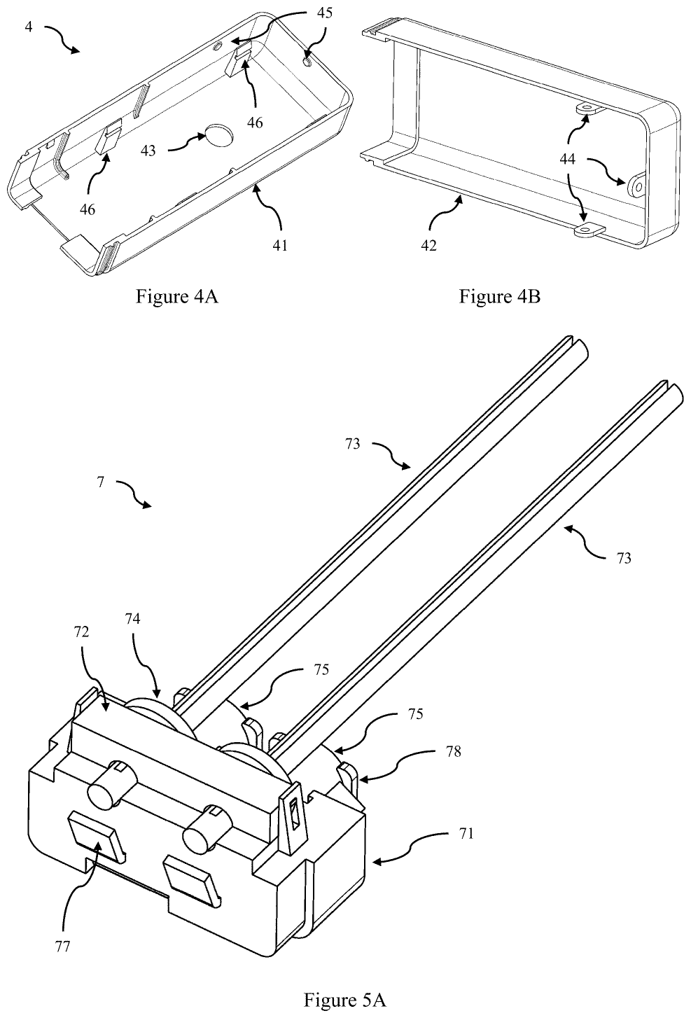

The upper housing is shown in more detail in FIGS. 4A and 4B which are isometric views of the upper section 41 and lower section 42 which clip together to form the rear housing 4 via matching retention tabs 44 and retention projections 45 located on opposite housings 41, 42. The housing may encapsulate the electronic control circuit 5 and power supply 6. In this embodiment the electronic control circuit 5 comprises a printed circuit board (PCB) with a microcontroller and associated electronical components. The upper housing 41 also comprises internal supports 46 for supporting the PCB. Power to the electronic control circuit 5 is provided by power supply 6. In some embodiments the electronic control circuit may provide voltage and current regulation functionality. In one embodiment the power supply module 6 is a pair of AA batteries. Another embodiment the power supply module 6 is three AAA batteries. Such batteries are relatively cheap and have a long shelf life and can be installed during manufacture and left in the apparatus during storage and the long shelf live confers long shelf life to the apparatus whilst minimising setup time, as only reagent containers then need to be fitted prior to use. In other embodiment other battery technologies such as Lithium Polymer (LiPo) or other types of rechargeable batteries can be provided. These tend to be more expensive and require some additional preparation time. For example rechargeable LiPo batteries are typically delivered half charged, and need to be charged prior to use, and their use adds additional cost as recharging circuitry is required.

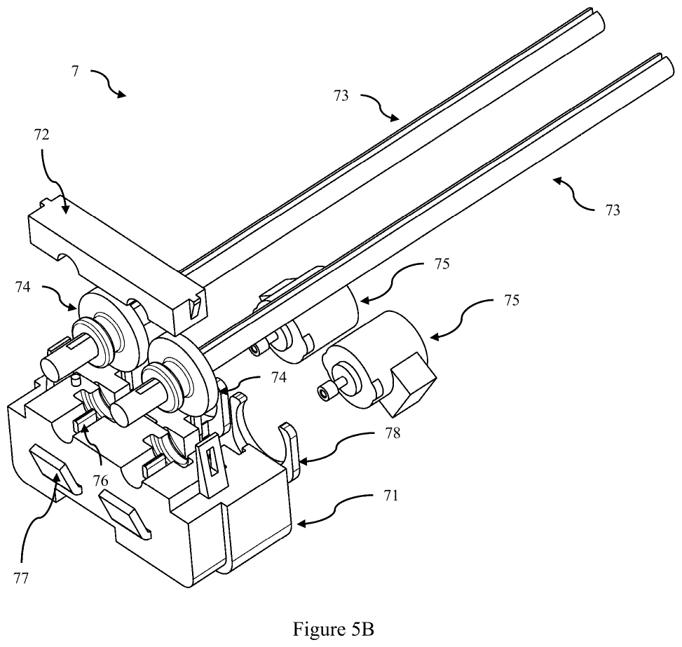

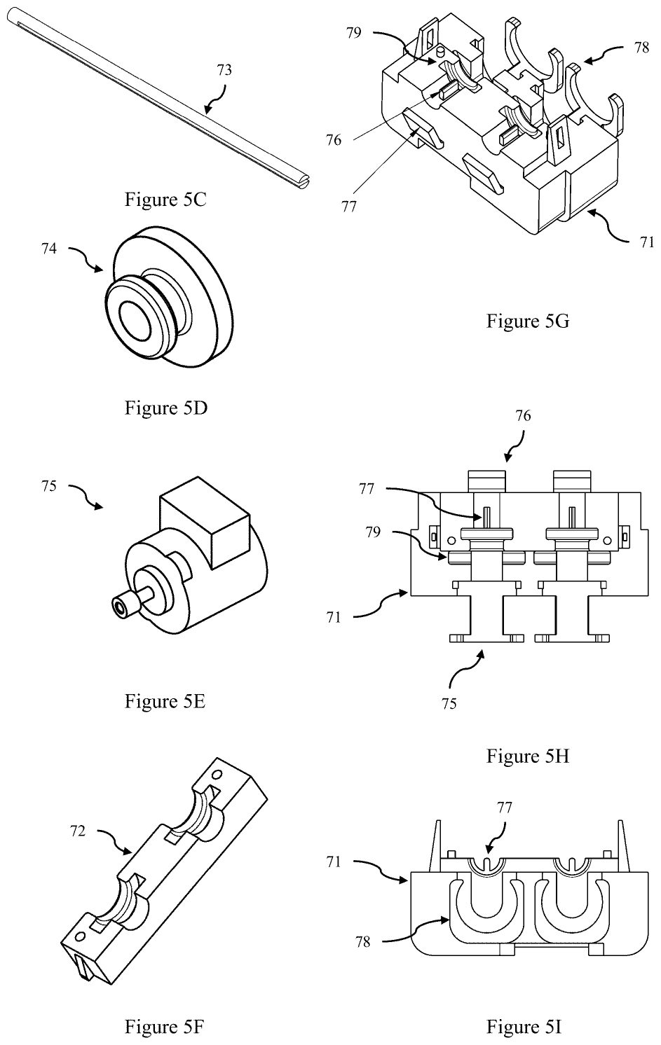

The housing 4 also houses the drive train arrangement 7, which is configured to drive the first reagent piston 84 into or from a distal end 81 of the first reagent container 8, and to drive the second reagent piston 94 into or from the distal end 91 of the second reagent container 9. FIGS. 5A and 5B are assembled and exploded isometric views of a drive train arrangement according to an embodiment. In this embodiment the electric drive train arrangement 7 comprises a first and second DC stepper motor drive 75, a first and second jack screw 73 and a gear set in the form of a jack spur gear 74 to transmit torque from each stepper motor 75 to the respective jack screw 73. FIGS. 5C, 5D, 5E each show isometric views of the jack screw 73, jack spur gear 74, and stepper motor 75 in the drive train arrangement of FIG. 5A. FIGS. 5G, 5H and 5I show isometric, top and end views a drive cradle 71 and FIG. 5F shows an isometric view of a drive cap 72. The drive cradle 71 comprises reagent retention springs 77 on the proximal face for engaging with the flanges 81 and 91 of the reagent containers. Another embodiment has the springs 77 located on the rear housing. The distal end of the drive cradle 71 comprises two stepper motor supports which support and receive the stepper motors 75 (see FIG. 5H). Additionally the body of the drive cradle 71 comprises a jack spur recess for receiving the jack spur gear and cut out for receiving the proximal end of the jack screw with the cut-out comprising anti rotation guides (or projections) which prevent lock and prevent rotation of the jack screws 73. The drive cap 72 sits over the proximal ends of the jack screws and jack spur gears to lock the drive train together.

The drive train arrangement 7 is controlled by the electronic control circuit 5 to control extrusion of the reagents from the first and second reagent containers 8 and 9 by controlling the speed of the stepper motors. Activation of the stepper motors by the electronic control circuit 5 drives rotation of the jack spur gear which in turn drives the jack screw forward to drive the reagent pistons 84 and 94 from a distal to a proximal position and force extrusion of reagents from the proximal (nozzle) end of the reagent containers 8 and 9. Prior to use a start-up purging operation can be performed to start flow through the tip to prepare it for surgical operation.

The microcontroller comprises embedded software for monitoring the state of the on/off switch 32, and controls the speed of the stepper motors (and thus extrusion rate) based on changes in detected changes in state. For a simple on/off embodiment with a constant (fixed) extrusion rate, the microcontroller stores a fixed speed (which may be stored as a frequency, voltage or a current level) for each stepper motor. The speed may be the same for each stepper motor, in which case the reagents are extruded at the same rate, or different speeds may be used for each stepper motor, in which case the reagents are extruded at different rates. This choice will depend upon the material or chemical properties of the reagents, or the desired application. In some embodiments the rate of extrusion of the first and second reagents is a mechanically fixed ratio with 2 jack screws 73 driven by a common motor.

In some embodiments, the user can control the extrusion speed or flow rate via a user interface 51 such as a knob, one or more buttons, or other speed control actuator that allows a user to set or change the rate of extrusion. In the embodiment shown in FIG. 4A an aperture is provided in the upper section to allow a speed control knob 51 projects through the upper section from the PCB 5. In these embodiments, the knob or button may have a number of predefined positions (e.g. 2, 3 or 4 positions) or digital states, with each position corresponding to a different speed, for example fast/slow (2 states), or fast/medium/slow (3 states). In this embodiment, the microcontroller stores a predefined speed for each motor (reagent) for each state, and controls the stepper motors at the stored speed corresponding to the selected state. This provides the user with limited speed control which can be preconfigured to match the needs of specific surgical applications (for example different steps in a procedure may use different speeds). Determination of the predefined speeds may be obtained through calibration processes. Alternatively or addition to adjusting speed, a user input could be used to alter the mixing ratio.

In some embodiments, for example for research uses or specialised surgical applications, variable (i.e. continuous or semi-continuous) speed control over a predefined range may be desired. This may be in the form of an analog speed control knob in which the angle of the knob corresponds to a speed over a predefined range (e.g. a rheostat) or a digital system in which the rotation through a defined arc (or angular steps) is detected and corresponds to a fixed speed step change, with the angle of rotation defining the direction of change (increase or decrease) between maximum and minimum limits. Additionally in some embodiments the rate of extrusion of the first and second reagents (and first and second stepper motors) is independently controllable. This may be through providing two speed control actuators or a combination of actuators such as knobs and buttons, for example a button may enable selection of which reagent, and a knob enables selection of speed. Alternatively a button or multiple buttons may be used to select pre-set speeds and or extrusion ratios.

In some embodiments the viscosity of reagents is temperature dependent and thus in some embodiments heating elements and sensors such as a Peltier cell system are provided, for example in the handgrip and the electronic control circuit 5 is used to heat and then maintain the temperature of inserted reagent containers 8 and 9 at a predefined temperature. Control of the temperature can also be used as a form of speed control (or in conjunction with speed control) by enabling control of the viscosity. Alternatively one or more temperature sensors may be included and the control system may vary the extrusion rate (e.g. stepper motor speed) of one or both of the reagents to compensate for changes in viscosity or mixing rate with temperature to ensure consistent application or mixing of the reagents. This may be based on calibration data.

In one embodiment the desired speed control or flow rate setting for a reagent is encoded on the reagent container so that when inserted in the handgrip a sensor reads or detects the encoded speed control or flow rate setting, and sends this information to the microcontroller. The microcontroller can then use this information to set the speed of the corresponding stepper motor. In some embodiment the encoded value may be a voltage or current level which the microcontroller can directly use, or the microcontroller may store sets of predefined speeds/control values each associated with a code, and thus by reading the code on the reagent container the microcontroller can look up the appropriate speed setting. The encoding maybe a physical encoding such as projection in a defined location on the flange which engages a switch, or a barcode or similar code printed on the reagent which is scanned and read by a light sensor in the handgrip housing.

In one embodiment the inventive biopen apparatus is preloaded with batteries and provided in a sterile container as a disposable apparatus. At the time of use, the sterile container is opened, and reagent containers 8 and 9 are loaded into the device. Once the operation is completed the entire device is disposed of Through the use of cheap and long lasting AA(A) batteries, fixed speed/extrusion rate (i.e. simple electronic circuit) and construction using injection moulding techniques the cost of the device can be kept low, whilst also providing a long shelf life (largely depending upon the shelf life of the batteries). In another embodiment the biopen is disposable but additionally allows limited speed control (i.e. 2, 3, or 4 speeds). That is the apparatus is supplied in a sterile condition, and reagents can be loaded and reloaded during use (whilst maintaining sterility), and after use apparatus is disposed of

In other embodiments the biopen could be reusable and sterilisable, or be comprised of disposable parts and sterilisable parts, or segmented between sterilisable (contacts the operator) and non-sterile (isolated from the operator). In one embodiment the nozzle 2 and handgrip 3 (i.e. the parts contacting the patient and operator) is separable from the rear housing 4, and the nozzle 2 and handgrip 3 are either disposable or can be sterilised using radiation or an autoclave, and the rear housing containing the electronics, mechanical components and batteries is sterilised using an alcohol swab or bath (70-85% ethanol). In this case the batteries are replaced and/or recharged between uses. Additionally the reagents can be loaded and reloaded during use (whilst maintaining sterility).

In one embodiment the embedded software performs additional functions such as reloading or error detection. This may include detecting an empty reagent container condition (or full extension of the jack screw) in which case extrusion is ceased and the user is alerted to replace the reagent. Similarly the software could detect an input from a user to change reagents and automatically shuts off the light source and retracts the piston actuators to allow reloading. The software could also be used to control an initial purge to ready the device for operation. The software could also monitor the drive arrangement or flow through the tip and detect an extrusion error (e.g. blocked extruder or blocked tip) in which case operation is ceased and the user alerted. The software could also detect failure of the light source in which case extrusion is ceased and the user is alerted. The software could also detect a low battery voltage and alert the user. The user could be alerted using one or more externally visible LED's located on the housing and turned on or strobed when an error condition is detected. In one embodiment the electronic control circuit comprises a wireless communications chip to allow wireless control of the apparatus. The software may perform the above tasks by turning on an acoustic signal instead of using visible LED's. In one embodiment a combination of acoustic and light signals may be used.

Other variations can be used to drive the reagent pistons 84 and 94. For example the drive train arrangement could comprise a stepper motor drive with a worm gear, rack and guide or a linear stepper motor with a leadscrew/jackscrew guide. In one embodiment a brushed DC motor drive is used with a jack screw, jackscrew guide, and a double worm reduction gear set to transmit torque from the motor to the jack screw at a much reduced speed, with a ratio in the range of 80-300:1, and a worm gear with provision for a magnet to facilitate sensing of the motor shaft to regulate motor speed. In one embodiment the drivetrain is a brushless DC motor drive with a jack screw, jack screw guide and a gear set to transmit torque from the motor to the jack screw.

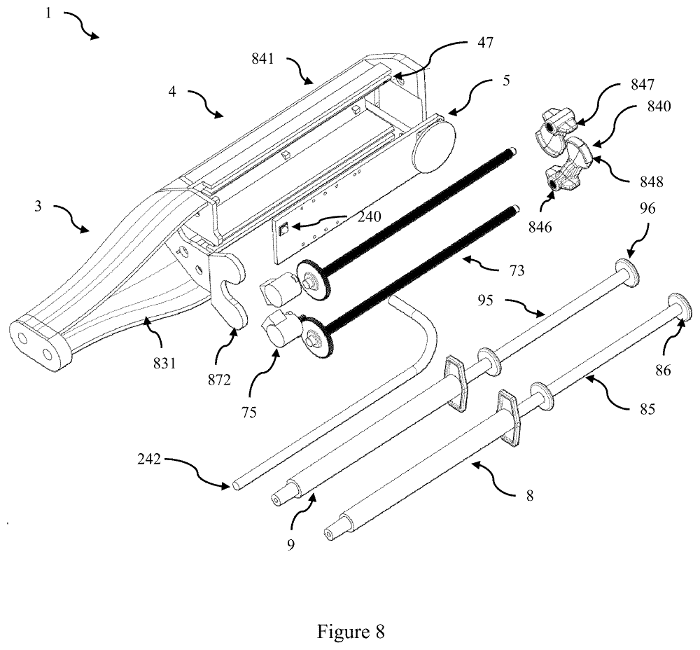

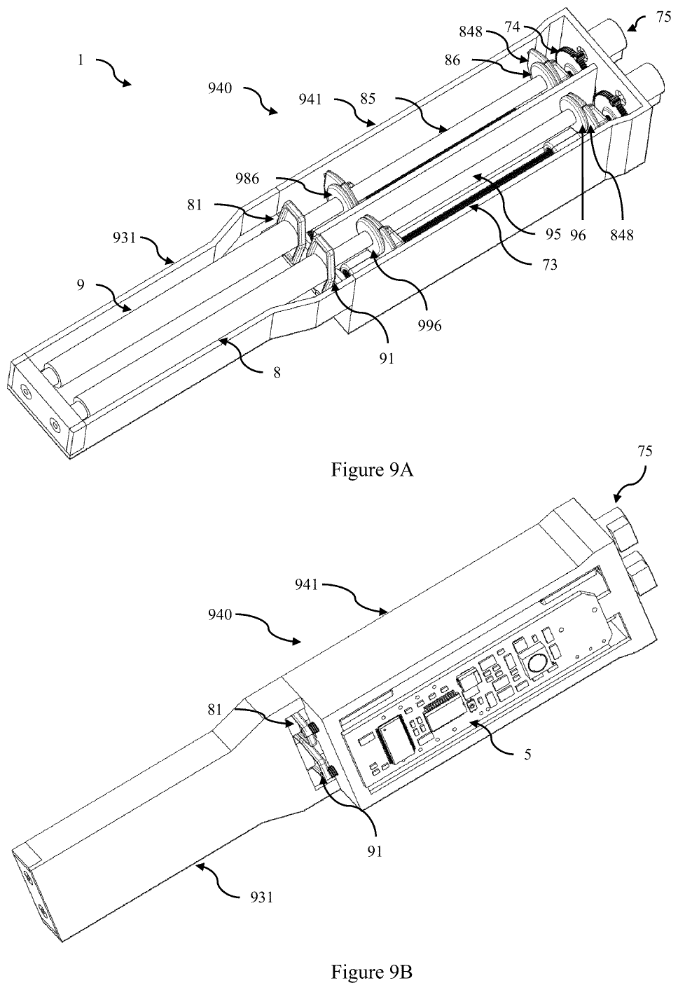

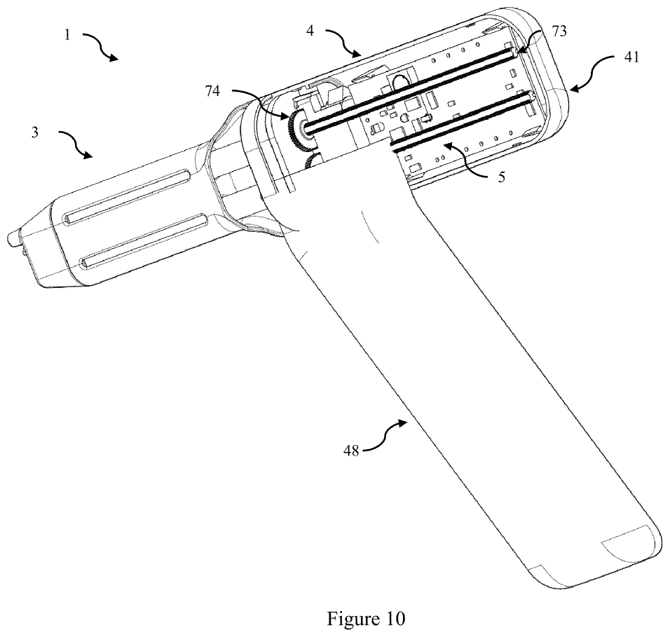

Other embodiments include a side loading embodiment, shown in exploded isometric view in FIG. 8, a rear loading embodiment shown in isometric views in FIGS. 9A and 9B. The side loading embodiment shown in FIG. 8 comprises a handgrip housing 831 and rear grip housing 841 which houses batteries and PCB board 5. This embodiment uses standard 1 ml syringes 8 and 9, and the drive arrangement comprises a plunger actuator 840 which comprises a threaded aperture 846 which receives the jack screw shaft 73. The plunger actuator 840 further comprises an actuator plate 848 for pushing the plunger (or piston) stops of the syringe plungers 85 and 95, and an anti-rotation feature 847, which in this case is a flange that is received in anti-rotation slot 47 located in the rear housing 841. This ensures that when the jack screw is rotated, the plunger actuator is prevented from rotation and thus forces the actuator plate to move axially along the jack screw (via threads in the threaded aperture 846), and thus plunge or retract the piston in the syringe. A motor retention plate 872 is located at the junction of the handgrip housing 831 and rear grip housing 841. The rear loading embodiment shown in FIGS. 9A and 9B is another embodiment that is configured to receive standard 1 ml syringes. In this embodiment a single housing 940 comprises handgrip portion 931 that houses the syringe reagent containers 8 and 9, and a (joined) rear housing portion 941 that houses the drive assembly 7, the syringe plungers 85 and 95, and the PCB 5 which is located on the rear of the housing 940. This arrangement uses the same drive arrangement as that shown in FIG. 8 with plunger actuators 840 located on jack screws 73. The plunger stops 86 and 96 are shown in a distal location and proximal location 986 and 996. FIG. 10 shows another embodiment in which the housing further includes a pistol grip 48 extending roughly orthogonally from the main housing body 4.

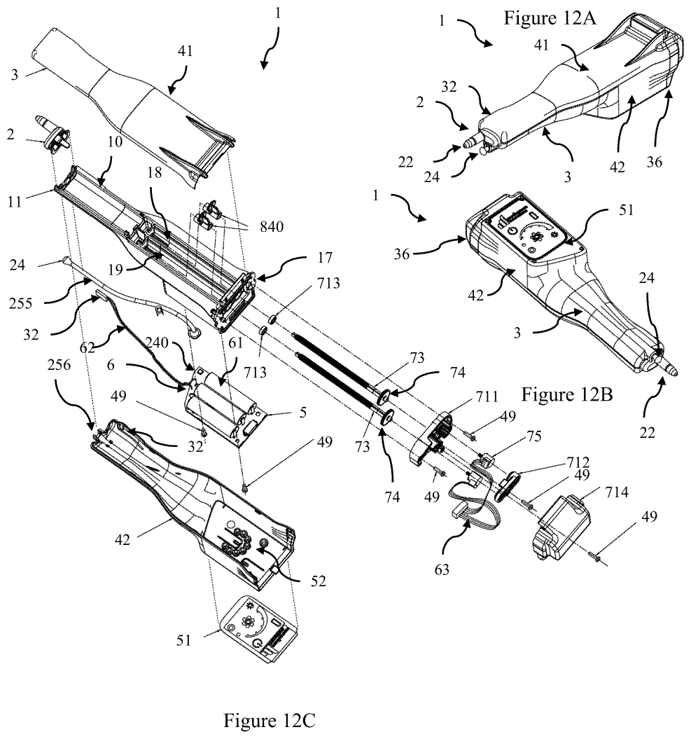

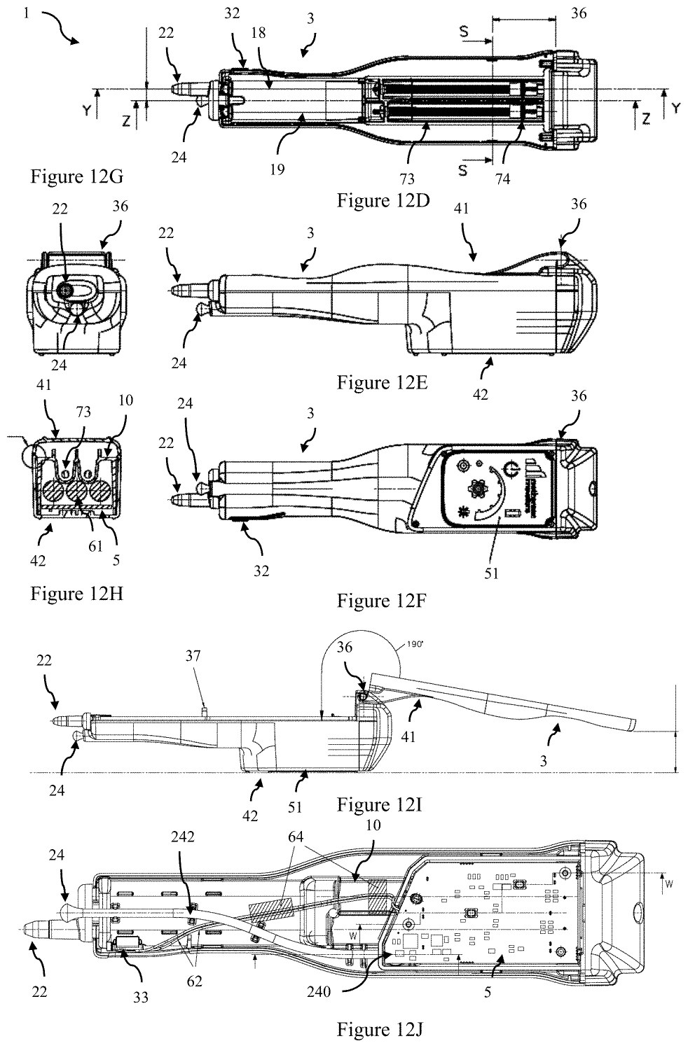

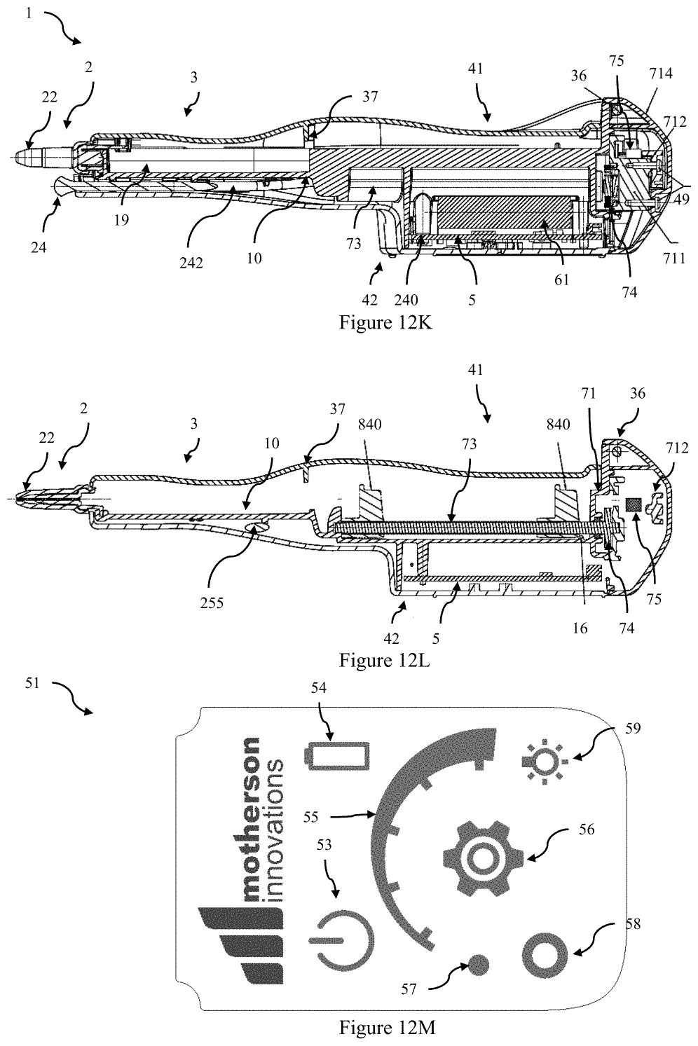

FIGS. 12A to 12M show another embodiment of a biopen apparatus 1 with a rear hinge allowing top loading of syringes. FIGS. 12A and 12B show isometric views and 12E, 12F and 12G show side bottom and front views of the biopen apparatus, and FIG. 12I shows side view with the top cover open and flipped back. FIG. 12D is a top view with the upper housing (top cover) 41 removed, FIG. 12J is a bottom view of the embodiment shown in FIG. 12A with the lower housing (lower cover) 42 removed. FIGS. 12H, 12K and 12L are sectional views through sections SS, YY and ZZ of FIG. 12D respectively.

As can be seen in these embodiments, the apparatus comprises a frame 10 which in turn supports the nozzle assembly 2, reagent containers 8 and 9 (not shown) in cavities 18, 19, drive assembly 7, control module 5 and power supply 6. The housing surrounds the frame and comprises an upper housing 41, a lower housing 42, and a rear motor cover 714. In this context relative locations such as upper, lower, forward or proximal, and rear or distal are referenced with respect to the nozzle tip when held by a user. The upper housing 41 has a cradle shape and comprises clips on the inside surfaces to allow the housing 10 to be clipped into the lower housing 42. The nozzle assembly 2 projects forward of the proximal (or forward) ends of the upper housing and lower housings 41 and 42. The lower housing 42 is connected to the rear motor cover 714 using a hinge 36 that allows the upper housing 41 to hinge upwards and rearward as shown in FIG. 12J. In this embodiment hinging through an opening angle of up to a point where the upper end of the upper housing 41 is the same level of the lower housing 42 is possible. The opening should be at least 90° in order to allow for an easy replacement of the reagent containers. It is also possible that the upper housing open with an angle of 270° so that in case the user has the BioPen in its hands the upper end of the upper housing points downwards. On one embodiment the upper housing may flip through 90° to 270°. For example, the opening angle may be 90°, 100°, 110°, 120°, 130°, 140°, 150°, 160°, 170°, 180°, 190°, 200°, 210°, 220°, 230°, 240°, 250, 260° or 270° or any other angle. A latch 37 is formed on the inside upper surface of the lower housing 42 which engages with the inside of the upper housing to retain the upper housing in a closed position. In other embodiments the hinge is located in a rear portion of the housing to allow the upper housing component 41 to flip through at least 90° to provide internal access to allow loading of reagent containers. In some embodiments non-biocompatible materials and components are separated from the operating environment by mechanically sealed enclosures. In some embodiments the upper housing 41 (or an upper portion of the housing) is transparent to allow viewing of the reagent containers and actuators. In some embodiment the frame 10 and upper housing 41 (or an upper portion of the housing) are embossed with lettering to locate the reagents in the correct position.

The housing is moulded so that the biopen apparatus can be comfortably held by a user's hand with the upper housing 41 comprising a bump near the palm and a depression near the fingertip region of the handgrip portion 3. A start/stop button 32 is located on the proximal side of the lower housing 42 which engages with actuator 33 to allow a user to control extrusion of material from the biopen. The start/stop button is formed as an extrusion button in the side of the lower housing 42. In one embodiment a user interface 51 as shown in FIG. 12M is located on the lower housing 42 (underside when held) of the biopen.

The drive assembly comprises two jack screw (shafts) that pass through apertures in the rear wall 17 of the frame 10 and end in jack spur gears 74 which is held in place by a retainer 712, which is mounted to the frame 10 and rear motor cover 714 via screws 49. The retainer 712 also supports the stepper motors 79. Plunger actuators 840 are mounted on the jack screw such that rotation of the jack screw moves the plunger actuators 840 forward (or rearward) to drive the plungers of the syringes (located in the forward or handgrip portion) to extrude material.

In this embodiment the power supply comprises three 1.5V AAA type batteries which are located in a battery compartment on the underside of the frame 10, and above the PCB circuit board on which is mounted control electronics including a microprocessor and power circuits to respond to user interface signals and to control the operation of the apparatus. Wires 63 run from the PCB on the underside of the frame 10 to the start/stop button 32, and wires 65 run from the PCB to the stepper motors 75 to control extrusion. A UV LED 240 is mounted on the top surface of the PCB, and a light pipe 242 directs the UV light to the tip of the nozzle 2 to provide a UV light source 24 to cure extruded material. FIG. 12J is a bottom view with the lower housing 42 removed to show the light pipe path 242 and underside of PCB 5 which comprises actuators 52 which receive user inputs via the user interface 51 and LEDs for indicating status to the user interface 51.

The user interface is configured to allow a user to control the rate of extrusion of the reagents from the first and second reagent containers, and select between at least two operating modes (for example manual and automatic). As shown in the embodiment of FIG. 12M the user interface 51 comprises an on/off power button 53, a battery indicator (e.g. green for good power and red for low power) 54, a speed indicator 55, which may be provided as a series of lamps (or lamp segments) to indicate the current speed of the device, or to allow the user to set the extrusion speed. A setting control button 56 allows a user to select an operating mode, for example one of a predefined set of operating modes. The user interface further comprises a purge core indicator lamp 57 and purge shell indicator lamp 58, and a curing mode light 59 (for example when the UV lamp is on and/or post illumination as the extruded material cures). An audible beep (65 dBA) may be used to confirm user input and signal faults. Indicator LEDs are mounted on the PCB and may directly illuminate associated indicators on the user interface 51, or may use light pipes to direct light to the user interface 51.

In one embodiment, the “on” state is indicated by the presence of at least one illuminated light. The biopen apparatus can be configured so that the illuminated light cycles clockwise or counter clockwise and cycles back to the starting position once the end is reached. The default configuration is to cycle clockwise starting in the purge Shell position. By default:

The curing lamp is not illuminated during purging;

The curing lamp is on low power during extrusion to facilitate a pre-cure, configurable to any pattern and/or percentage of full power (set at the factory);

The light is applied at any configurable percentage or pattern (set at the factory) in light only mode. No other functions are active;

The curing light is illuminated in time limited periods to facilitate control over light dose/curing of materials.

In other embodiments the curing lamp may be applied intermittently during extrusion to create desirable mechanical properties in the extruded material.

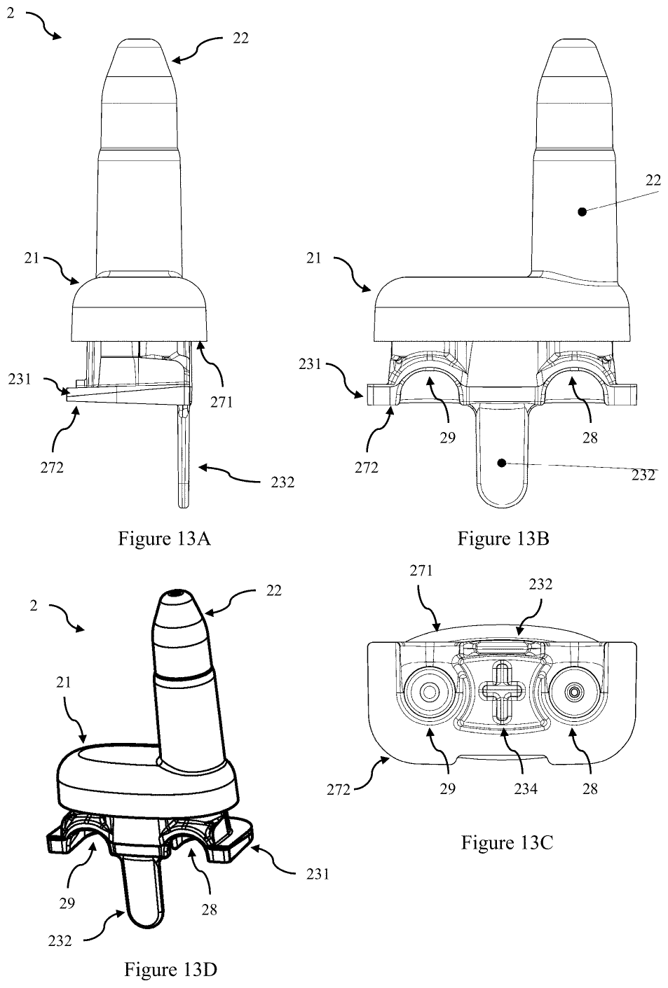

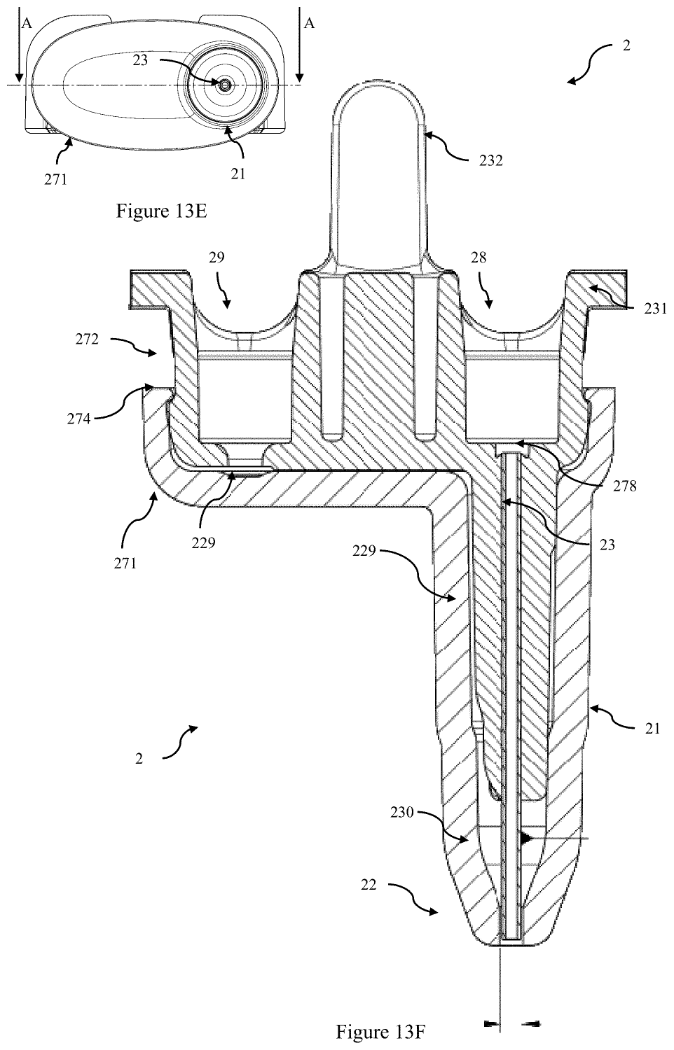

FIGS. 13A to 13F show various views of the nozzle assembly 2 of this embodiment. FIGS. 13A, 13B, 13C, 13D, and 13E show two side, top, end, isometric and top views, and FIG. 13F is a section view of the nozzle assembly through section AA of FIG. 13E. In this embodiment the nozzle assembly 2 is formed of a cap portion 271 and nozzle portion 272.

Both the cap portion 271 and nozzle portion 272 are designed to be formed using injection molding processes with the ability to control tolerances to a high level. The cap 271 is moulded and stripped from the undercut in the tool while still hot permitting a peripheral clip retention feature 274 to be formed. The nozzle portion 272 is moulded over the hypodermic tube 23 in a single operation. Specialised tooling is required for holding the tube in place during moulding. The nozzle portion 272 forms the mechanical interface with the frame 10 and seals to the syringes via a Luer slip interface.

The cap portion 271 is a clip/interference fit on the nozzle portion 272 forming a fluid tight seal once pressed into position negating the need for any additional sealing method. The cap portion 271 also forms a fluid manifold 229 guiding the shell material from the syringe to a concentric ring 230 around the hypodermic tube 23 thus forming a coaxial extrusion. In other embodiments the nozzle assembly is sealed with an o-ring and fastened with one or more screws.

The nozzle assembly (2) may be integrated into the housing, i.e. may be permanently fixed so that it cannot be removed from the biopen. In one embodiment, the nozzle assembly (2) is removable from and attachable to the housing. This allows to attach different types of nozzle assemblies (2) to the biopen depending on the application for which the biopen should be used. For example, by replacing the nozzle assembly (2) it is possible to have differing blend system, such as the first reagent being extruded throughout a core aperture (23) and the second reagent being extruded through an annular aperture (25), whereas by replacing the nozzle assembly (2) the first reagent may be extruded throughout an annular aperture (25) and the second reagent may be extruded through an a core aperture (23). The possibility of replacing the nozzle assembly may also allow to replace defect or clogged nozzles assemblies.

The nozzle assembly 2 is an example of a separate assembly to the frame 10 to permit changing of the nozzle assembly if damaged, or at a device level, refinement of the nozzle assembly design for alternate applications. Alternate configurations may include side by side extrusion, different geometric shapes, different length nozzles, different diameter nozzles, different geometric ratios etc. The rear of the nozzle portion 272 comprises a rear shoulder, which as shown in FIG. 12L creates cavity with the distal end of the cap portion 271 within which is received the proximal ends of the upper and lower housings 41 and 42, and the proximal end of the frame 10 to secure the nozzle assembly 2 in place. A flat rearwardly extending projection 234 located on the upper side of the nozzle portion 272 acts as a retaining surface for a clip formed on the underside of upper housing 41.

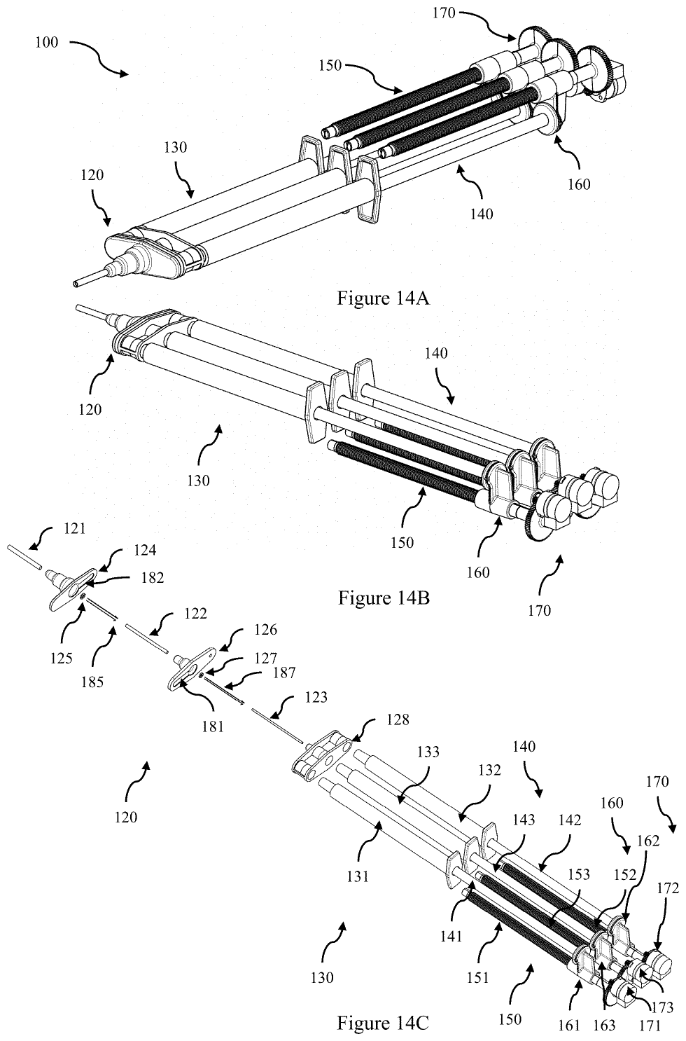

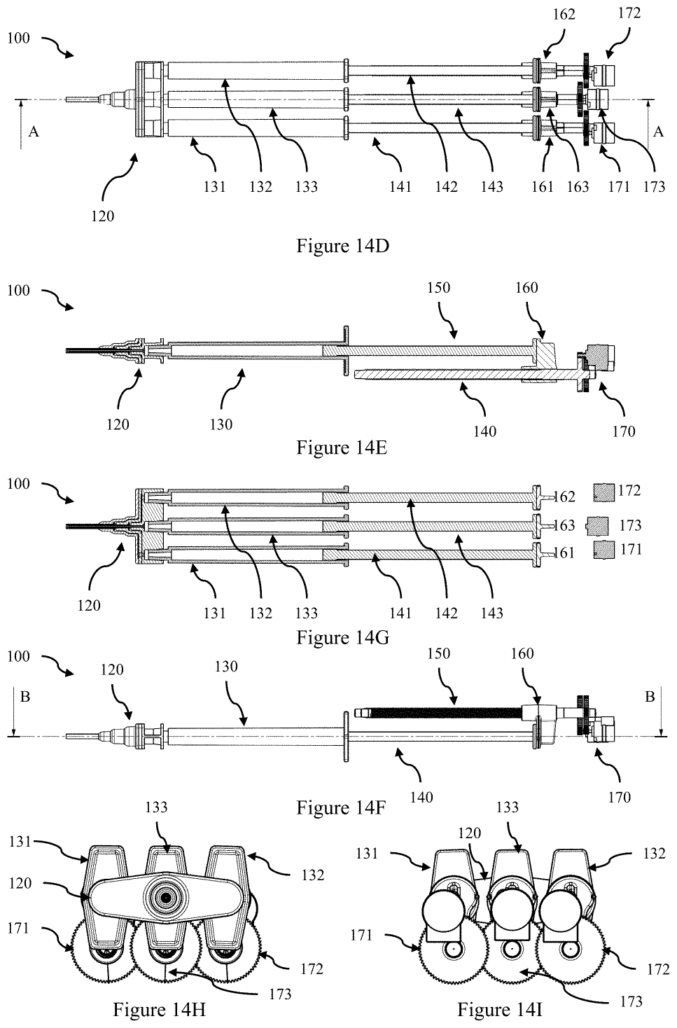

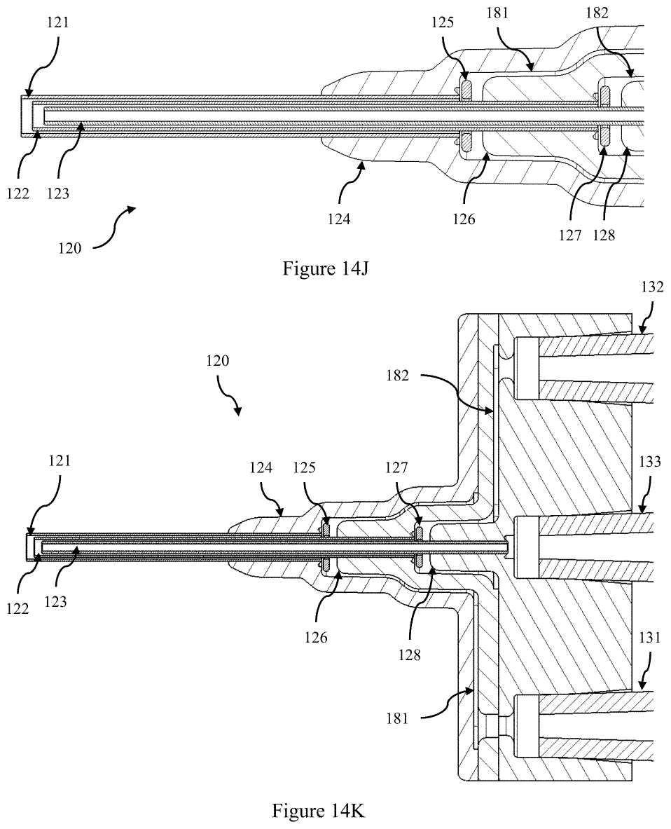

The biopen as described in the embodiments above may be further modified to include additional reagent containers and to co-extrude these additional reagents. In these embodiments the previously described reagent support arrangements and the electric drive train arrangement is further configured to drive each additional reagent piston into a distal end of the additional reagent container, and the nozzle is further configured to receive the additional reagent driven out of a proximal end of each additional reagent container and co-extrude each additional reagent with the first and second reagents. In such embodiments, the biopen may comprise at the distal end of each reagent container a flange with a unique profile shape, and each reagent container support arrangement may comprise a cut-out portion matching the unique profile shape. FIGS. 14A to 14J show another embodiment of a triple barrel concentric syringe assembly 100. This embodiment facilitates the placement of a tri-axial bead of material and is straightforwardly adapted to any desired number of coaxial elements. FIGS. 14A, 14B, 14D, 14F, 14H, and 14I show a first isometric, a second isometric, top, side, front and rear views, whilst FIG. 14C shows an exploded view, and FIGS. 14E and 14G show section views through sections AA and BB of FIGS. 14D and 14G respectively. In this embodiment the nozzle 120 is a triple concentric tube arrangement that interfaces with syringes 130 to extrude a central bead of material with a coaxial construction via plungers 140 driven by plunger actuators 160 mounted on jackscrews 150 driven by stepper motors 170. In this embodiment each of the three syringes (131, 132, 133), are driven by identical and separately controlled drive assemblies (i.e. syringe 131 and plunger 141 are driven by plunger actuator 161 on jackscrew 151 driven by stepper motor 171; syringe 132 and plunger 142 are driven by plunger actuator 162 on jackscrew 152 driven by stepper motor 172; and syringe 133 and plunger 143 are driven by plunger actuator 163 on jackscrew 153 driven by stepper motor 173). In this embodiment each of the three independent syringe and drive assemblies are arranged side by side, or stacked, in the same plane. As shown in FIGS. 14D and 14I, the location of the central jack spur gear and motor 173 is longitudinally (or distally) offset relative to the adjacent jack spur gears to reduce the lateral width of the triple syringe assembly.

In this embodiment the central syringe 133 delivers the core material, and the two outermost syringes 131 and 132 (each adjacent to the central syringe) deliver the outer and intermediate shell materials respectively. FIGS. 14J and 14K are close up views of the nozzle assembly of FIGS. 14E and 14G respectively showing orthogonal sections. As with the two material embodiments the delivery tube (tip 21) is formed of concentric hypodermic tubes 121, 122, 123, in the nozzle which is overmoulded. The nozzle assembly 120 comprises an outer cap 124 with an integral overmoulded outer tube 121, an intermediate manifold 126 with an integral overmoulded intermediate tube 122 and a nozzle base manifold 128 with an integral overmoulded core tube 123 and three receiving cavities for receiving the central core syringe 133, the intermediate syringe 132 and the outer syringe 131 respectively.

The tubes 121, 122 and 123 are sized to permit nesting and the construction of the tri-axial (or N axial) bead of extruded material. The stacked assembly uses die plates with three fine wires between each nested tube to maintain the coaxial alignment. For example as shown in exploded view 14C and section views 14J and 14K, cap die plate 125 is located on the inner (distal) sides of cap manifold 124 and receives spacing guide wires 185 which spaces apart intermediate tube 122 and outer tube 121, and similarly intermediate die plate 127 is located on the inner (distal) sides of intermediate manifold 126 and receives spacing guide wires 187 which spaces apart core tube 123 and intermediate tube 122. In another embodiment the tubes can have a trilobular profile to facilitate coaxial location. In another embodiment the tubes can have additively manufactured location features integrated onto the tubes.

Cap 124, intermediate manifold 126 and nozzle base manifold 128 when stacked form the fluid manifolds to each respective tube and sealing faces. As shown in exploded view 14C and section views 14J and 14K, cap manifold 124 comprises a outer channel 181 located on the inner (proximal) side of the cap manifold 124 leading from the outer syringe 131 (via aperture in the nozzle base manifold 128) and intermediate manifold 126 comprises a intermediate channel 182 located on the inner (proximal) side of the intermediate manifold 126 leading from intermediate syringe 132 (via aperture in the nozzle base 128). Additional sealant, glue or gaskets may be applied in some embodiments.

In other embodiments the present system could be extended to add additional syringe assemblies to extrude N-axial beads of material. i.e. using 4, 5, 6, 7 or even more syringes. Generally, N materials and N associated syringes and drive assemblies may be used, wherein N is an integer, for example from 1 to 10. In other embodiments, other geometrical layouts could be used such as distributing the syringe and driver arrangements around a central axis (e.g. at 0°, 120° and 240°) and redesigning the manifolds (or fluid delivery channels) in the nozzle 120.

Thus, the of the invention may generally be used for extruding radiation curable reagent compositions. The radiation curable reagent composition may additionally cured by using the handheld 3D printing apparatus, for example using a light source which is part of the biopen. In one embodiment the light source may be an external light source.

Embodiments of the handheld 3D printing apparatus or biopen have a number of surgical and research uses. For example the biopen can be used for repairing defects of an mammalian body. Such defect may be, but not limit to, tissue defects or bone defects. In one embodiment, the repair relates to biological materials which are unable to self-repair such as cartilage or corneal tissue. In such applications the biopen can be used to directly write 3D living cells onto the damaged area for tissue or bone regeneration. For example cartilage is unable to self-repair and can become damaged through physical activities, wear, trauma or degenerative conditions. A biopen loaded with appropriate stem cells can be used to perform in-situ repair, and current surgical interventions are of limited effectiveness. It is also possible to use the biopen for cell types capable of repair, such as skin or bones. In such cases the biopen could be used to directly print or write living cells onto damaged tissue to assist with the repair process. For example bone stem cells and bone growth factors could be printed on fractures or in other bone surgery such as spinal fusions to stimulate bone growth. Similarly keratinocytes and other skin cells could be directly printed onto cuts, abrasions or burns to stimulate skin repair and minimise scar tissue formation.

FIGS. 11A to 11C illustrate an exemplary repair process using the biopen loaded with stem cells which have been cultured to differentiate down a chondrocyte lineage. For example adipose stem cells when cultured with appropriate growth factors can be directed to differentiate into chondrocytes. FIG. 11A shows a section of knee cartilage 110 with a damaged section 120. The surgeon can optionally excise a section 130 to remove the damaged tissue as shown in FIG. 11B, and then as shown in FIG. 11C the biopen can be used to directly print a biomaterial 140 into the excised section 130. In this case the surgeon draws a series of adjacent lines across the excised section 130 until the section 130 is completely filled in creating an in-situ repair.

In one embodiment the handheld 3D printing apparatus or biopen may be mounted to a robot or robot arm.

Embodiments of the handheld 3D printing apparatus or biopen have a number of advantages. First the biopen is suitable for cost effective production using high volume manufacturing techniques and processes. For example the nozzle, handgrip and housings can be cheaply manufactured using high throughput techniques such as injection moulding using thermoplastic and/or thermosetting polymers. In particular the nozzle has been carefully designed to ensure consistent flow of materials whilst also being suitable for cheap and easy construction. Additionally the system features improved reliability through the use of drive system using a micro-controlled electronic (DC) jack screw. Additionally the microcontroller can be used to tightly control the temperature of the reagent containers to ensure consistent flow rates. The apparatus is an all-in-one unit, featuring an internal power supply, and is ergonomically designed to fit easily in the hand giving the user greater freedom of movement and ease of use. The apparatus is designed to allow easy and fool-proof reagent loading through the use of a hinged opening with different shaped loading bays to ensure that each reagent is loaded (and can only be loaded) into the correct bay. In one embodiment the biopen can be cost effectively manufactured as a single purpose disposable item which delivers a specific reagent at a constant rate without requiring any control by the user (other than on/off control). In other embodiments more sophisticated control system can be incorporated for the biopen allowing the user greater control over the extrusion of the reagents.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims. Thus, it will be appreciated that there may be other variations and modifications to the compositions described herein that are also within the scope of the present invention.

1-20. (canceled)

21. A handheld 3D printing apparatus for extruding multiple reagent compositions, the apparatus comprising:
a housing, comprising:
a first reagent container support arrangement which, in use, receives and supports a first reagent container containing a cell supporting reagent;
a second reagent container support arrangement which, in use, receives and supports a second reagent container containing a light curable reagent;
a power supply;
an electric drive train arrangement configured to drive a first reagent piston into a distal end of the first reagent container, and to drive a second reagent piston into a distal end of the second reagent container;
an electronic control circuit to control the electric drive train to control extrusion of the reagents from the first and second reagent containers; and
a nozzle connected at a distal end of the housing and comprising
a co-extrusion tip comprising at least one aperture;
a first conduit for receiving the first reagent driven out of a proximal end of the first reagent container and directing the first reagent out of the at least one aperture in the tip; and
a second conduit for receiving the second reagent driven out of a proximal end of the second reagent container and directing the second reagent out of the at least one aperture in the tip.

22. The handheld 3D printing apparatus of claim 21, wherein the nozzle comprises
a core aperture;
an annular aperture in a coaxial arrangement with the core aperture;
a first conduit for receiving the first reagent driven out of the proximal end of the first reagent container and directing the first reagent out of the core aperture in the tip; and
a second conduit for receiving the second reagent driven out of the proximal end of the second reagent container and directing the second reagent out of the annular aperture in the tip.

23. The handheld 3D printing apparatus of claim 21, wherein at least one of:
the handheld 3D printing apparatus comprises a light source mounted on or in the handheld 3D printing apparatus and controlled by the electronic control circuit for curing the reagents either prior or after extrusion from the tip; and
the housing comprises a hinged portion to allow the housing to be opened to receive and load the first and second reagent container.

24. The handheld 3D printing apparatus of claim 23, wherein at least one of:
the distal end of the first reagent container comprises a flange with a first profile shape, the first reagent container support arrangement comprises a cut-out portion matching the first profile shape, the distal end of the second reagent container comprises a flange with a second profile shape different to the first profile shape, and the second reagent container support arrangement comprises a cut-out portion matching the second profile shape;
the housing comprises a handgrip connected to a rear housing comprising the power supply, electronic control circuit and electric drive train arrangement, the hinged portion is formed in the handgrip, and the first and second reagent containers are loaded into the handgrip; and
the hinge is located in a rear portion of the housing to allow an upper housing component to flip through at least 90° up to 270° to provide internal access to allow loading of the first and second reagent containers.

25. The handheld 3D printing apparatus of claim 21, further comprising
a first aperture for viewing the first reagent in the first reagent container; and
a second aperture for viewing the second reagent in the second reagent container.

26. The handheld 3D printing apparatus of claim 21, wherein the nozzle is formed by plastic injection molding with a first cavity for receiving the proximal end of the first reagent container, a second cavity for receiving the proximal end of the second reagent container, the co-extrusion tip comprising a single tube leading to a manifold with a first conduit to the first cavity and a second conduit to the second cavity, and the co-extrusion tip being formed by inserting a core tube into the single tube and through the manifold and into the first conduit.

27. The handheld 3D printing apparatus of claim 21, wherein the nozzle is formed as a nozzle assembly of two plastic injection molded parts comprising a cap portion and a nozzle portion, and
wherein the nozzle assembly is sealed with an O-ring and fastened with one or more screws or the nozzle assembly is sealed with an interference fit and fastened with a clip.

28. The handheld 3D printing apparatus of claim 21, wherein non-biocompatible materials and components are separated from an operating environment by mechanically sealed enclosures.

29. The handheld 3D printing apparatus of claim 21, further comprising a user interface configured to allow a user to control a rate of extrusion of the reagents from the first and second reagent containers, and select between at least two operating modes.

30. The handheld 3D printing apparatus of claim 21, wherein an upper portion of the housing is transparent to allow viewing of the reagent containers and actuators, wherein a frame and upper portion of the housing are embossed with lettering to locate the reagents in a correct position.

31. The handheld 3D printing apparatus of claim 23, wherein the light source is mounted remote to the nozzle and a light pipe directs light from the light source to the extruded material.

32. The handheld 3D printing apparatus of claim 21, wherein a rate of extrusion of the first and second reagents is independently controllable, or the rate of extrusion of the first and second reagents is a mechanically fixed ratio.

33. The handheld 3D printing apparatus of claim 21, wherein the electric drive train arrangement comprises:
a first and second stepper motor drive;
a first and second jack screw; and
a gear set to transmit torque from each stepper motor to a respective one of the first and second jack screws.

34. The handheld 3D printing apparatus of claim 21, wherein the handheld 3D printing apparatus is preloaded with batteries and provided in a sterile container as a disposable apparatus.

35. The handheld 3D printing apparatus of claim 21, further comprising one or more additional reagent container support arrangements which, in use, each receives and support an additional reagent container,
wherein the electric drive train arrangement is further configured to drive each additional reagent piston into a distal end of the additional reagent container, and the nozzle is further configured to receive the additional reagent driven out of a proximal end of each additional reagent container and co-extrude each additional reagent with the first and second reagents.

36. The handheld 3D printing apparatus of claim 35, wherein at least one of:
the distal end of each additional reagent container comprises a flange with a unique profile shape, and each reagent container support arrangement comprises a cut-out portion matching the unique profile shape,
the electric drive train arrangements and reagent container support arrangements are configured to drive each additional reagent piston into the distal end of each additional reagent container, and
the nozzle is configured to receive the additional reagent driven out of the proximal end of each additional reagent container and co-extrude each additional reagent with the first and second reagents.

37. A method of using the handheld 3D printing apparatus of claim 21, comprising extruding a radiation curable reagent composition, wherein the radiation curable reagent composition is additionally cured using the handheld 3D printing apparatus.

38. A nozzle assembly for use in the handheld 3D printing apparatus of claim 21, wherein the nozzle assembly is attachable to and removable from the housing.

39. The nozzle assembly of claim 38, wherein at least one of:
the nozzle comprises configurations comprising side-by-side extrusion, different geometric shapes, different length nozzles, different diameter nozzles, or different geometric ratios, and
the nozzle assembly is formed by injection molding processes.

40. The nozzle assembly of claim 38, the nozzle assembly containing at least three guide wires and guide wire alignment disk, wherein the three guide wires are positioned within an annular aperture.
